SEQUENCE LISTING (2 sequences)

SEQ ID NO: 1 - protein, 773 aa, Bacillus sp. AA349 DSM 12648
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 2 - protein, 824 aa, Bacillus sp. KSMS237 FERM P-16067
MMLRKKTKQLISSILILVLLLSLFPAALAAEGNTREDNFKHLLGNDNVKRPSEAGALQLQEVDGQMTLVDQHGEKIQLRGMSTHGLQWFPEILNDNAYKALSNDWDSNMIRLAMYVGENGYATNPELIKQRVIDGIELAIENDMYVIVDWHVHAPGDPRDPVYAGAKDFFREIAALYPNNPHIIYELANEPSSNNNGGAGIPNNEEGWKAVKEYADPIVEMLRKSGNADDNIIIVGSPNWSQRPDLAADNPIDDHHTMYTVHFYTGSHAASTESYPSETPNSERGNVMSNTRYALENGVAVFATEWGTSQASGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSANGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEAVKEEKKEAKEEKKAVKNEAKKK

(19) United States
(12) Patent Application Publication
(10) Pub. No.: US 2010/0022431 A1
(43) Pub. Date: Jan. 28, 2010

(54) Detergent Compositions

(75) Inventors: Neil Joseph Lant, Newcastle upon Tyne (GB); Steven George Patterson, Tyne & Wear (GB)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/818,648

(22) Filed: Jun. 15, 2007

(30) Foreign Application Priority Data
Jun. 16, 2006 (EP) 06115574.3
Jul. 7, 2006 (EP) 06116782.1

(51) Int. Cl. C11D 7/42; C12S 9/00

(52) U.S. Cl. 510/392

(57) ABSTRACT

Detergent compositions containing an alkaline bacterial enzyme exhibiting endo-beta-1,4-glucanase activity (E.C. 3.2.1.4) and specific detergent formulations comprising less than 10 wt % zeolite and phosphate builder are described. Preferred formulations comprise surfactants selected from alkyl benzene sulphonates in combination with alkyl ethoxylated sulfates or MES or non-ionic surfactants.

### TECHNICAL FIELD

The present invention relates to laundry detergent compositions and in particular to detergents comprising an alkaline bacterial enzyme exhibiting endo-beta-1,4-glucanase activity (E.C. 3.2.1.4)

### BACKGROUND OF THE INVENTION AND PRIOR ART

Cellulase enzymes have been used in detergent compositions for many years now for their known benefits of depilling, softness and colour care. However, the use of most of cellulases has been limited because of the negative impact that cellulase may have on the tensile strength of the fabrics' fibers by hydrolysing crystalline cellulose. Recently, cellulases with a high specificity towards amorphous cellulose have been developed to exploit the cleaning potential of cellulases while avoiding the negative tensile strength loss. Especially alkaline endo-glucanases have been developed to suit better the use in alkaline detergent conditions.

For example, Novozymes in WO02/099091 discloses a novel enzyme exhibiting endo-beta-glucanase activity (EC 3.2.1.4) endogenous to the strain Bacillus sp., DSM 12648; for use in detergent and textile applications. Novozymes further describes in WO04/053039 detergent compositions comprising an anti-redeposition endo-glucanase and its combination with certain cellulases having increased stability towards anionic surfactant and/or further specific enzymes. Kao's EP 265 832 describes novel alkaline cellulase K, CMCase I and CMCase II obtained by isolation from a culture product of Bacillus sp KSM-635. Kao further describes in EP 1 350 843, alkaline cellulase which acts favourably in an alkaline environment and can be mass produced readily because of having high secretion capacity or having enhanced specific activity.

The problem facing the present inventors was how to maximise performance from this new generation of cellulases. The present inventors found that whilst a small benefit could be achieved formulating such enzymes according to present day detergent formulations by simply replacing existing cellulase enzymes with the new generation of enzymes, a considerable improvement in performance was found by formulating the detergent compositions in a different way and even reducing the levels of some conventional detergent ingredients. Indeed, it has been surprisingly found that the use of very low levels of builder, or even complete absence of inorganic builder, enhances the cleaning performance of the bacterial alkaline cellulase. Without wishing to be bound by theory, it is believed that (i) inorganic builders such as STPP, zeolites and silicates interact with hardness to form insoluble materials that deposit on fabrics and potentially interfere with the catalytic mechanism of the cellulase and that (ii) hardness ions such as Ca2+ and Mg2+ stabilise the enzyme in solution, and promote deposition of enzyme onto fabric surfaces. Therefore, the removal or reduction in builder is thus expected to increase free hardness levels leading to increased enzyme stability and surface deposition while increasing its activity on fabrics through reduced levels of encrustation.

### DEFINITION OF THE INVENTION

In accordance with the present invention there is provided a detergent composition comprising an alkaline bacterial enzyme exhibiting endo-beta-1,4-glucanase activity (E.C. 3.2.1.4) and comprising less than 10 wt % aluminosilicate (anhydrous basis) builder and less than 10 wt % phosphate builder, the composition having a reserve alkalinity of greater than 4.

In a preferred aspect of the invention, the detergent compositions of the invention comprise less than 10 wt % builders selected from aluminosilicate (zeolite) builder and/or phosphate builder. In a further preferred aspect of the invention, the compositions comprise less than 8 wt % zeolite, or even less than 4 wt % and less than 8 wt % phosphate builder or even less than 4 wt %.

### SEQUENCE LISTINGS

SEQ ID NO: 1 shows the amino acid sequence of an endoglucanase from Bacillus sp. AA349

SEQ ID NO: 2 shows the amino acid sequence of an endoglucanase from Bacillus sp KSM-S237

### DETAILED DESCRIPTION OF THE INVENTION

### Suitable Endoglucanase

The endoglucanase to be incorporated into the detergent composition of the present invention is one or more bacterial alkaline enzyme(s) exhibiting endo-beta-1,4-glucanase activity (E.C. 3.2.1.4) and is typically comprised at a level of from 0.00005% to 0.15%, from 0.0002% to 0.02%, or even from 0.0005% to 0.01% by weight of pure enzyme of one or more endoglucanase.

As used herein, the term “alkaline endoglucanase”, shall mean an endoglucanase having an optimum pH above 7 and retaining greater than 70% of its optimal activity at pH 10.

Preferably, the endoglucanase is a bacterial polypeptide endogenous to a member of the genus Bacillus. More preferably, the alkaline enzyme exhibiting endo-beta-1,4-glucanase activity (E.C. 3.2.1.4), is a polypeptide containing (i) at least one family 17 carbohydrate binding module (Family 17 CBM) and/or (ii) at least one family 28 carbohydrate binding module (Family 28 CBM). Please refer for example to: Current Opinion in Structural Biology, 2001, 593-600 by Y. Bourne and B. Henrissat in their article entitled: “Glycoside hydrolases and glycosyltransferases: families and functional modules” for the definition and classification of CBMs. Please refer further to Biochemical Journal, 2002, v361, 35-40 by A. B. Boraston et al in their article entitled: “Identification and glucan-binding properties of a new carbohydrate-binding module family” for the properties of the family 17 and 28 CBM's.

In a more preferred embodiment, said enzyme comprises a polypeptide (or variant thereof) endogenous to one of the following Bacillus species.

| Bacillus sp. | As described in: |
|---|---|
| AA349 (DSM 12648) | WO 2002/099091A (Novozymes) p2, |
| | line 25 |
| | WO 2004/053039A (Novozymes) p3, |
| | line19 |
| KSM S237 | EP 1350843A (Kao) p3, line 18 |
| 1139 | EP 1350843A (Kao) p3, line 22 |
| KSM 64 | EP 1350843A (Kao) p3, line 24 |
| KSM N131 | EP 1350843A (Kao) p3, line 25 |
| KSM 635, FERM BP 1485 | EP 265 832A (Kao) p7, line 45 |
| KSM 534, FERM BP 1508 | EP 0271044A (Kao) p9, line 21 |
| KSM 539, FERM BP 1509 | EP 0271044 A (Kao) p9, line 22 |
| KSM 577, FERM BP 1510 | EP 0271044 A (Kao) p9, line 22 |
| KSM 521, FERM BP 1507 | EP 0271044 A (Kao) p9, line 19 |
| KSM 580, FERM BP 1511 | EP 0271044 A (Kao) p9, line 20 |
| KSM 588, FERM BP 1513 | EP 0271044 A (Kao) p9, line 23 |
| KSM 597, FERM BP 1514 | EP 0271044 A (Kao) p9, line 24 |
| KSM 522, FERM BP 1512 | EP 0271044 A (Kao) p9, line 20 |
| KSM 3445, FERM BP 1506 | EP 0271044 A (Kao) p10, line 3 |
| KSM 425. FERM BP 1505 | EP 0271044 A (Kao) p10, line 3 |

Suitable endoglucanases for the compositions of the present invention are:

1) An enzyme exhibiting endo-beta-1,4-glucanase activity (E.C. 3.2.1.4), which has a sequence of at least 90%, preferably 94%, more preferably 97% and even more preferably 99%, 100% identity to the amino acid sequence of position 1 to position 773 of SEQ ID NO:1 (Corresponding to SEQ ID NO:2 in WO02/099091); or a fragment thereof that has endo-beta-1,4-glucanase activity, when identity is determined by GAP provided in the GCG program using a GAP creation penalty of 3.0 and GAP extension penalty of 0.1. The enzyme and the corresponding method of production is described extensively in patent application WO02/099091 published by Novozymes A/S on Dec. 12, 2002. Please refer to the detailed description pages 4 to 17 and to the examples page 20 to page 26. One of such enzyme is commercially available under the tradename Celluclean™ by Novozymes A/S.

GCG refers to the sequence analysis software package provided by Accelrys, San Diego, Calif., USA. This incorporates a program called GAP which uses the algorithm of Needleman and Wunsch to find the alignment of two complete sequences that maximises the number of matches and minimises the number of gaps.

2) Also suitable are the alkaline endoglucanase enzymes described in EP 1 350 843A published by Kao corporation on Oct. 8, 2003. Please refer to the detailed description [0011] to [0039] and examples 1 to 4 [0067] to [0077] for a detailed description of the enzymes and its production. The alkaline cellulase variants are obtained by substituting the amino acid residue of a cellulase having an amino acid sequence exhibiting at least 90%, preferably 95%, more preferably 98% and even 100% identity with the amino acid sequence represented by SEQ. ID NO:2 (Corresponding to SEQ. ID NO:1 in EP 1 350 843 on pages 11-13) at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, or (p) position 608 in SEQ ID NO:2 or at a position corresponding thereto with another amino acid residue

Examples of the “alkaline cellulase having the amino acid sequence represented by SEQ. ID NO:2” include Egl-237 [derived from Bacillus sp. strain KSM-S237 (FERM BP-7875), Hakamada, et al., Biosci. Biotechnol. Biochem., 64, 2281-2289, 2000]. Examples of the “alkaline cellulase having an amino acid sequence exhibiting at least 90% homology with the amino acid sequence represented by SEQ. ID NO:2” include alkaline cellulases having an amino acid sequence exhibiting preferably at least 95% homology, more preferably at least 98% homology, with the amino acid sequence represented by SEQ. ID NO:2. Specific examples include alkaline cellulase derived from Bacillus sp. strain 1139 (Egl-1139) (Fukumori, et al., J. Gen. Microbiol., 132, 2329-2335) (91.4% homology), alkaline cellulases derived from Bacillus sp. strain KSM-64 (Egl-64) (Sumitomo, et al., Biosci. Biotechnol. Biochem., 56, 872-877, 1992) (homology: 91.9%), and cellulase derived from Bacillus sp. strain KSM-N131 (Egl-N131b) (Japanese Patent Application No. 2000-47237) (homology: 95.0%).

The amino acid is preferably substituted by: glutamine, alanine, proline or methionine, especially glutamine is preferred at position (a), asparagine or arginine, especially asparagine is preferred at position (b), proline is preferred at position (c), histidine is preferred at position (d), alanine, threonine or tyrosine, especially alanine is preferred at position (e), histidine, methionine, valine, threonine or alanine, especially histidine is preferred at position (f), isoleucine, leucine, serine or valine, especially isoleucine is preferred at position (g), alanine, phenylalanine, valine, serine, aspartic acid, glutamic acid, leucine, isoleucine, tyrosine, threonine, methionine or glycine, especially alanine, phenylalanine or serine is preferred at position (h), isoleucine, leucine, proline or valine, especially isoleucine is preferred at position (i), alanine, serine, glycine or valine, especially alanine is preferred at position (j), threonine, leucine, phenylalanine or arginine, especially threonine is preferred at position (k), leucine, alanine or serine, especially leucine is preferred at position (l), alanine, aspartic acid, glycine or lysine, especially alanine is preferred at position (m), methionine is preferred at position (n), valine, threonine or leucine, especially valine is preferred at position (o) and isoleucine or arginine, especially isoleucine is preferred at position (p).

The “amino acid residue at a position corresponding thereto” can be identified by comparing amino acid sequences by using known algorithm, for example, that of Lipman-Pearson's method, and giving a maximum similarity score to the multiple regions of similarity in the amino acid sequence of each alkaline cellulase. The position of the homologous amino acid residue in the sequence of each cellulase can be determined, irrespective of insertion or depletion existing in the amino acid sequence, by aligning the amino acid sequence of the cellulase in such manner (FIG. 1 of EP 1 350 843). It is presumed that the homologous position exists at the three-dimensionally same position and it brings about similar effects with regard to a specific function of the target cellulase.

With regard to another alkaline cellulase having an amino acid sequence exhibiting at least 90% homology with SEQ. ID NO:2, specific examples of the positions corresponding to (a) position 10, (b), position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564 and (p) position 608 of the alkaline cellulase (Egl-237) represented by SEQ. ID NO: 2 and amino acid residues at these positions will be shown below:

| | Egl-237 | Egl-1139 | Egl-64 | Egl-N131b |
|---|---|---|---|---|
| (a) | 10Leu | 10Leu | 10Leu | 10Leu |
| (b) | 16Ile | 16Ile | 16Ile | Nothing corresponding thereto |
| (c) | 22Ser | 22Ser | 22Ser | Nothing corresponding thereto |
| (d) | 33Asn | 33Asn | 33Asn | 19Asn |
| (e) | 39Phe | 39Phe | 39Phe | 25Phe |
| (f) | 76Ile | 76Ile | 76Ile | 62Ile |
| (g) | 109Met | 109Met | 109Met | 95Met |
| (h) | 242Gln | 242Gln | 242Gln | 228Gln |
| (i) | 263Phe | 263Phe | 263Phe | 249Phe |
| (j) | 308Thr | 308Thr | 308Thr | 294Thr |
| (k) | 462Asn | 461Asn | 461Asn | 448Asn |
| (l) | 466Lys | 465Lys | 465Lys | 452Lys |
| (m) | 468Val | 467Val | 467Val | 454Val |
| (n) | 552Ile | 550Ile | 550Ile | 538Ile |
| (o) | 564Ile | 562Ile | 562Ile | 550Ile |
| (p) | 608Ser | 606Ser | 606Ser | 594Ser |

3) Also suitable is the alkaline cellulase K described in EP 265 832A published by Kao on May 4, 1988. Please refer to the description page 4, line 35 to page 12, line 22 and examples 1 and 2 on page 19 for a detailed description of the enzyme and its production. The alkaline cellulase K has the following physical and chemical properties:
(1) Activity: Having a Cx enzymatic activity of acting on carboxymethyl cellulose along with a weak C₁ enzymatic activity and a weak beta-glucoxidase activity;
(2) Specificity on Substrates: Acting on carboxymethyl cellulose (CMC), crystalline cellulose, Avicell, cellobiose, and p-nitrophenyl cellobioside (PNPC);
(3) Having a working pH in the range of 4 to 12 and an optimum pH in the range of 9 to 10;
(4) Having stable pH values of 4.5 to 10.5 and 6.8 to 10 when allowed to stand at 40° C. for 10 minutes and 30 minutes, respectively;
(5) Working in a wide temperature range of from 10 to 65° C. with an optimum temperature being recognized at about 40° C.;
(6) Influences of chelating agents: The activity not impeded with ethylenediamine tetraacetic acid (EDTA), ethyleneglycol-bis-(β-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;
(7) Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alpha-olefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;
(8) Having a strong resistance to proteinases; and
(9) Molecular weight (determined by gel chromatography): Having a maximum peak at 180,000±10,000.

Preferably such enzyme is obtained by isolation from a culture product of Bacillus sp KSM-635.

Cellulase K is commercially available by the Kao Corporation: e.g. the cellulase preparation Eg-X known as KAC® being a mixture of E-H and E-L both from Bacillus sp. KSM-635 bacterium. Cellulases E-H and E-L have been described in S. Ito, Extremophiles, 1997, v1, 61-66 and in S. Ito et al, Agric Biol Chem, 1989, v53, 1275-1278.

4) The alkaline bacterial endoglucanases described in EP 271 004A published by Kao on Jun. 15, 1988 are also suitable for the purpose of the present invention. Please refer to the description page 9, line 15 to page 23, line 17 and page 31, line 1 to page 33, line 17 for a detailed description of the enzymes and its production. Those are:

Alkaline Cellulase K-534 from KSM 534, FERM BP 1508,
Alkaline Cellulase K-539 from KSM 539, FERM BP 1509,
Alkaline Cellulase K-577 from KSM 577, FERM BP 1510,
Alkaline Cellulase K-521 from KSM 521, FERM BP 1507,
Alkaline Cellulase K-580 from KSM 580, FERM BP 1511,
Alkaline Cellulase K-588 from KSM 588, FERM BP 1513,
Alkaline Cellulase K-597 from KSM 597, FERM BP 1514,
Alkaline Cellulase K-522 from KSM 522, FERM BP 1512,
Alkaline Cellulase E-II from KSM 522, FERM BP 1512,
Alkaline Cellulase E-III from KSM 522, FERM BP 1512.
Alkaline Cellulase K-344 from KSM 344, FERM BP 1506, and
Alkaline Cellulase K-425 from KSM 425, FERM BP 1505.

5) Finally, the alkaline endoglucanases derived from Bacillus species KSM-N described in JP2005287441A, published by Kao on the Oct. 20, 2005, are also suitable for the purpose of the present invention. Please refer to the description page 4, line 39 to page 10, line 14 for a detailed description of the enzymes and its production. Examples of such alkaline endoglucanases are:

Alkaline Cellulase Egl-546H from Bacillus sp. KSM-N546
Alkaline Cellulase Egl-115 from Bacillus sp. KSM-N115
Alkaline Cellulase Egl-145 from Bacillus sp. KSM-N145
Alkaline Cellulase Egl-659 from Bacillus sp. KSM-N659
Alkaline Cellulase Egl-640 from Bacillus sp. KSM-N440

Also encompassed in the present invention are variants of the above described enzymes obtained by various techniques known by persons skilled in the art such as directed evolution.

### Builders

Commercially available laundry detergents comprise strong inorganic builder, with either phosphate builder typically sodium tripolyphosphate (STPP), or zeolite typically sodium aluminosilicate builder, being used as the predominant strong builder. Generally such strong builders are present at relatively high levels such as 15 to 20 wt % or even higher, for example even up to 40 wt %. In accordance with the present invention, the amount of strong builder selected from phosphate and/or zeolite builder is no greater than 10 wt % based on the total weight of the detergent composition, preferably below 8 wt %, or even below 5 or 4 or 3 or 2 or 1 wt %.

Thus, the compositions of the invention may comprise from 0 wt % to 10 wt % zeolite builder, and 0 wt % to 10 wt % phosphate builder, the total amount of phosphate and/or zeolite not exceeding 10 wt %, and preferably being below 10 wt % as described above. Preferably the compositions of the invention comprise from 0 wt % to 8 wt %, or from 0 wt % to 5 or 4 wt %, or from 0 wt % to 3 or even less than 2 wt % zeolite builder. It may even be preferred for the composition to be essentially free from zeolite builder. By essentially free from zeolite builder it is typically meant that the composition comprises no deliberately added zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

The compositions of the invention may comprise from 0 wt % to 10 wt % phosphate builder. The composition preferably comprises from 0 wt % to 8 wt %, or from 0 wt % to 5 or 4 wt %, or from 0 wt % to 3 or even 2 wt % phosphate builder. It may even be preferred for the composition to be essentially free from phosphate builder. By essentially free from phosphate builder it is typically meant that the composition comprises no deliberately added phosphate builder. This is especially preferred if it is desirable for the composition to have a very good environmental profile. Phosphate builders include sodium tripolyphosphate.

In a further preferred aspect of the invention, the total level of weak builders selected from layered silicate (SKS-6), citric acid, citrate salts and nitrilo triacetic acid or salt thereof is below 15 wt %, more preferably below 8 wt %, more preferably below 4 wt % or even below 3 or 2 wt % based on the total weight of the detergent composition. Typically the level of each of layered silicate, citric acid, citrate salts and nitrilo triacetic acid or salt thereof will be below 10 wt % or even below 5 wt % or wt % based on the total weight of the composition.

Although builders bring several benefits to the formulator, their main role is to sequester divalent metal ions (such as calcium and magnesium ions) from the wash solution that would otherwise interact negatively with the surfactant system. Builders are also effective at removing metal ions and inorganic soils from the fabric surface too, leading to improved removal of particulate and beverage stains. It would therefore be expected that reduction of their levels would negatively impact on cleaning performance and therefore, preparation of detergent compositions that are effective with the claimed reduced levels of phosphate and zeolite builders is surprising.

### Reserve Alkalinity

As used herein, the term “reserve alkalinity” is a measure of the buffering capacity of the detergent composition (g/NaOH/100 g detergent composition) determined by titrating a 1% (w/v) solution of detergent composition with hydrochloric acid to pH 7.5 i.e in order to calculate Reserve Alkalinity as defined herein:

$$Reserve Alkalinity ( to pH 7.5 ) as \% alkali in g NaOH \text{/} 100 \text{g} product = \frac{T \times M \times 40 \times Vol}{10 \times Wt \times Aliquot}$$

T=titre (ml) to pH 7.5
M=Molarity of HCl=0.2
40=Molecular weight of NaOH
Vol=Total volume (ie. 1000 ml)
Wt=Weight of product (10 g)
Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free deionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls±1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.5. Note the millilitres of hydrochloric acid used. Take the average titre of three identical repeats. Carry out the calculation described above to calculate RA to pH 7.5.

The RA will be greater than 4 and preferably greater than 6 and most preferably greater than 7.5 or even greater than 8 or 8.5 or higher.

It has been found that a robust alkalinity system is beneficial in the detergent compositions of the invention. Adequate reserve alkalinity may be provided, for example, by one or more of alkali metal silicates (excluding crystalline layered silicate), typically amorphous silicate salts, generally 1.2 to 2.2 ratio sodium salts, alkali metal typically sodium carbonate, bicarbonate and/or sesquicarbonates. STPP and persalts such as perborates and percarbonates also contribute to alkalinity. Buffering is necessary to maintain an alkaline pH during the wash process counteracting the acidity of soils.

The detergent composition preferably comprises from 0 wt % to 50 wt % silicate salt, more usually 5 to 30 wt % silicate salt, or 7 to 20 wt % silicate salt, usually sodium silicate.

In order to provide the desired reserve alkalinity the detergent compositions of the invention may comprise a carbonate salt, typically from 1 wt % to 70 wt %, or from 5 wt % to 50 wt % or from 10 wt % to 30 wt % carbonate salt. Preferred carbonate salts are sodium carbonate and/or sodium bicarbonate and/or sodium sesquicarbonate. The carbonate salt may be incorporated into the detergent composition wholly or partially via a mixed salt such as Burkeite. A highly preferred carbonate salt is sodium carbonate. Preferably, the composition may comprise from 5 wt % to 50 wt % sodium carbonate, or from 10 to 40 wt % or even 15 to 35 wt % sodium carbonate. It may also be desired for the composition to comprise from 1 wt % to 20 wt % sodium bicarbonate, or even 2 to 10 or 8 wt %.

If zeolite is present, it may be desired for the weight ratio of sodium carbonate and/or sodium silicate to zeolite builder to be at least 5:1, preferably at least 10:1, or at least 15:1, or at least 20:1 or even at least 25:1

The carbonate salt, or at least part thereof, is typically in particulate form, typically having a weight average particle size in the range of from 200 to 500 micrometers. However, it may be preferred for the carbonate salt, or at least part thereof, to be in micronised particulate form, typically having a weight average particle size in the range of from 4 to 40 micrometers; this is especially preferred when the carbonate salt, or at least part thereof, is in the form of a co-particulate admixture with a detersive surfactant, such as an alkoxylated anionic detersive surfactant.

In order to provide the required reserve alkalinity, preferably the levels of carbonate and/or silicate salts, typically sodium carbonate and sodium silicate will be from 10 to 70 wt %, or from 10 or even 15 to 50 wt % based on the total weight of the composition.

### Further Ingredients

The compositions of the present invention may comprise further ingredients as described below. Preferred are the chelants and especially hydroxyethane-dimethylene-phosphonic acid (HEDP), 2-phosphonobutane-1,2,4-tricarboxylic acid (PBTC) and 4,5-dihydroxy-m-benzenedisulfonic acid, disodium salt (Tiron®). Indeed it is believed that the combination of the endoglucanase within the low builder system of the present invention with these chelants provide even better stain removal, cleaning and whiteness.

Another preferred ingredient is a fluorescent whitening agent, especially the following:

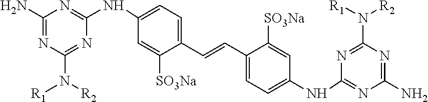

wherein R1 and R2, together with the nitrogen atom linking them, form an unsubstituted or C1-C4 alkyl-substituted morpholino, piperidine or pyrrolidine ring. Indeed it is believed that the combination of the endoglucanase within the low builder system of the present invention with these fluorescent whitening agents provide even better cleaning and whiteness.

### Surfactant

A highly preferred adjunct component of the compositions of the invention is a surfactant. Preferably, the detergent composition comprises one or more surfactants. Typically, the detergent composition comprises (by weight of the composition) from 0% to 50%, preferably from 5% and more preferably from 10 or even 15 wt % to 40%, or to 30%, or to 20% one or more surfactants. Preferred surfactants are anionic surfactants, non-ionic surfactants, cationic surfactants, zwitterionic surfactants, amphoteric surfactants, cationic surfactants and mixtures thereof.

### Anionic Surfactants

Suitable anionic surfactants typically comprise one or more moieties selected from the group consisting of carbonate, phosphate, phosphonate, sulphate, sulphonate, carboxylate and mixtures thereof. The anionic surfactant may be one or mixtures of more than one of C₈₋₁₈ alkyl sulphates and C₈₋₁₈ alkyl sulphonates. Suitable anionic surfactants incorporated alone or in mixtures in the compositions of the invention are also the C₈₋₁₈ alkyl sulphates and/or C₈₋₁₈ alkyl sulphonates optionally condensed with from 1 to 9 moles of C₁₋₄ alkylene oxide per mole of C₈₋₁₈ alkyl sulphate and/or C₈₋₁₈ alkyl sulphonate. The alkyl chain of the C₈₋₁₈ alkyl sulphates and/or C₈₋₁₈ alkyl sulphonates may be linear or branched, preferred branched alkyl chains comprise one or more branched moieties that are C₁₋₆ alkyl groups. More particularly, suitable anionic surfactants include the C₁₀-C₂₀ primary, branched-chain, linear-chain and random-chain alkyl sulphates (AS), typically having the following formula:

CH₃(CH₂)ₓCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

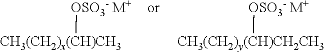

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, WO 00/23548 and mixtures thereof.

Preferred anionic surfactants are C₈₋₁₈ alkyl benzene sulphates and/or C₈₋₁₈ alkyl benzene sulphonates. The alkyl chain of the C₈₋₁₈ alkyl benzene sulphates and/or C₈₋₁₈ alkyl benzene sulphonates may be linear or branched, preferred branched alkyl chains comprise one or more branched moieties that are C₁₋₆ alkyl groups.

Other preferred anionic surfactants are selected from the group consisting of: C₈₋₁₈ alkenyl sulphates, C₈₋₁₈ alkenyl sulphonates, C₈₋₁₈ alkenyl benzene sulphates, C₈₋₁₈ alkenyl benzene sulphonates, C₈₋₁₈ alkyl di-methyl benzene sulphate, C₈₋₁₈ alkyl di-methyl benzene sulphonate, fatty acid ester sulphonates, di-alkyl sulphosuccinates, and combinations thereof. Other useful anionic surfactants herein include the esters of alpha-sulfonated fatty acids, typically containing from 6 to 20 carbon atoms in the fatty acid group and from 1 to 10 carbon atoms in the ester group; 2-acyloxy-alkane-1-sulfonic acid and salts thereof, typically containing from about 2 to 9 carbon atoms in the acyl group and from about 9 to 23 carbon atoms in the alkane moiety; alpha-olefin sulfonates (AOS), typically containing from about 12 to 24 carbon atoms; and beta-alkoxy alkane sulfonates, typically containing from about 1 to 3 carbon atoms in the alkyl group and from about 8 to 20 carbon atoms in the alkane moiety. Also useful are the sulphonation products of fatty acid esters containing an alkyl group typically with from 10 to 20 carbon atoms. Preferred are C₁₋₄, most preferably methyl ester sulphonates. Preferred are C₁₆₋₁₈ methyl ester sulphonates (MES).

The anionic surfactants may be present in the salt form. For example, the anionic surfactant(s) may be an alkali metal salt of any of the above. Preferred alkali metals are sodium, potassium and mixtures thereof.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates. Highly preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

It may be preferred for the anionic detersive surfactant to be structurally modified in such a manner as to cause the anionic detersive surfactant to be more calcium tolerant and less likely to precipitate out of the wash liquor in the presence of free calcium ions. This structural modification could be the introduction of a methyl or ethyl moiety in the vicinity of the head group of the anionic detersive surfactant, as this can lead to a more calcium tolerant anionic detersive surfactant due to steric hindrance of the head group, which may reduce the affinity of the anionic detersive surfactant for complexing with free calcium cations in such a manner as to cause precipitation out of solution. Other structural modifications include the introduction of functional moieties, such as an amine moiety, in the alkyl chain of the anionic detersive surfactant; this can lead to a more calcium tolerant anionic detersive surfactant because the presence of a functional group in the alkyl chain of an anionic detersive surfactant may minimise the undesirable physicochemical property of the anionic detersive surfactant to form a smooth crystal structure in the presence of free calcium ions in the wash liquor. This may reduce the tendency of the anionic detersive surfactant to precipitate out of solution.

### Alkoxylated Anionic Surfactants

The composition may comprise an alkoxylated anionic surfactant. Where present such a surfactant will generally be present in amounts from 0.1 wt % to 40 wt %, generally 0.1 to 10 wt % based on the detergent composition as a whole. It may be preferred for the composition to comprise from 3 wt % to 5 wt % alkoxylated anionic detersive surfactant, or it may be preferred for the composition to comprise from 1 wt % to 3 wt % alkoxylated anionic detersive surfactant.

Preferably, the alkoxylated anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the alkoxylated anionic detersive surfactant is a linear or branched, substituted or unsubstituted C₁₂₋₁₈ alkyl ethoxylated sulphate having an average degree of ethoxylation of from 1 to 10. Most preferably, the alkoxylated anionic detersive surfactant is a linear unsubstituted C₁₂₋₁₈ alkyl ethoxylated sulphate having an average degree of ethoxylation of from 3 to 7.

The alkoxylated anionic detersive surfactant may also increase the non-alkoxylated anionic detersive surfactant activity by making the non-alkoxylated anionic detersive surfactant less likely to precipitate out of solution in the presence of free calcium cations. Preferably, the weight ratio of non-alkoxylated anionic detersive surfactant to alkoxylated anionic detersive surfactant is less than 5:1, or less than 3:1, or less than 1.7:1, or even less than 1.5:1. This ratio gives optimal whiteness maintenance performance combined with a good hardness tolerency profile and a good sudsing profile. However, it may be preferred that the weight ratio of non-alkoxylated anionic detersive surfactant to alkoxylated anionic detersive surfactant is greater than 5:1, or greater than 6:1, or greater than 7:1, or even greater than 10:1. This ratio gives optimal greasy soil cleaning performance combined with a good hardness tolerency profile, and a good sudsing profile. Suitable alkoxylated anionic detersive surfactants are: Texapan LEST™ by Cognis; Cosmacol AES™ by Sasol; BES151™ by Stephan; Empicol ESC70/U™; and mixtures thereof.

### Non-Ionic Detersive Surfactant

The compositions of the invention may comprise non-ionic surfactant. Where present it is generally present in amounts of from 0.5 wt % to 20, more typically 0.5 to 10 wt % based on the total weight of the composition. The composition may comprise from 1 wt % to 7 wt % or from 2 wt % to 4 wt % non-ionic detersive surfactant. The inclusion of non-ionic detersive surfactant in the composition helps to provide a good overall cleaning profile, especially when laundering at high temperatures such as 60° C. or higher.

The non-ionic detersive surfactant can be selected from the group consisting of: C₁₂-C₁₈ CIS alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEₓ, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈₋₁₈ alkyl ethoxylated alcohol having an average degree of ethoxylation of from 1 to 50, more preferably from 3 to 40. Non-ionic surfactants having a degree of ethoxylation from 3 to 9 may be especially useful either. Nonionic surfactants having an HLB value of from 13 to 25, such as C₈₋₁₈ alkyl ethoxylated alcohols having an average degree of ethoxylation from 15 to 50, or even from 20 to 50 may also be preferred non-ionic surfactants in the compositions of the invention. Examples of these latter non-ionic surfactants are Lutensol AO30 and similar materials disclosed in WO04/041982. These may be beneficial as they have good lime soap dispersant properties.

The non-ionic detersive surfactant not only provides additional soil cleaning performance but may also increase the anionic detersive surfactant activity by making the anionic detersive surfactant less likely to precipitate out of solution in the presence of free calcium cations. Preferably, the weight ratio of non-alkoxylated anionic detersive surfactant to non-ionic detersive surfactant is in the range of less than 8:1, or less than 7:1, or less than 6:1 or less than 5:1, preferably from 1:1 to 5:1, or from 2:1 to 5:1, or even from 3:1 to 4:1.

### Cationic Detersive Surfactant

In one aspect of the invention, the detergent compositions are free of cationic surfactant. However, the composition optionally may comprise from 0.1 wt % to 10 or 5 wt % cationic detersive surfactant. When present however, preferably the composition comprises from 0.5 wt % to 3 wt %, or from 1% to 3 wt %, or even from 1 wt % to 2 wt % cationic detersive surfactant. This is the optimal level of cationic detersive surfactant to provide good cleaning. Suitable cationic detersive surfactants are alkyl pyridinium compounds, alkyl quaternary ammonium compounds, alkyl quaternary phosphonium compounds, and alkyl ternary sulphonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium surfactants as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:

(R)(R¹)(R²)(R³)N⁺X⁻

wherein, R is a linear or branched, substituted or unsubstituted C₆₋₁₈ alkyl or alkenyl moiety, R¹ and R² are independently selected from methyl or ethyl moieties, R³ is a hydroxyl, hydroxymethyl or a hydroxyethyl moiety, X is an anion which provides charge neutrality, preferred anions include halides (such as chloride), sulphate and sulphonate. Preferred cationic detersive surfactants are mono-C₆₋₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

The cationic detersive surfactant provides additional greasy soil cleaning performance. However, the cationic detersive surfactant may increase the tendency of any non-alkoxylated anionic detersive surfactant to precipitate out of solution. Preferably, the cationic detersive surfactant and any non-alkoxylated anionic detersive surfactant are separated in the detergent composition of the invention, for example if cationic surfactant is present, preferably the cationic and any anionic surfactant, particularly non-alkoxylated anionic surfactant will be present in the composition in separate particles. This minimises any effect that any cationic detersive surfactant may have on the undesirable precipitation of the anionic detersive surfactant, and also ensures that upon contact with water, the resultant wash liquor is not cloudy. If cationic surfactant is present, preferably the weight ratio of non-alkoxylated anionic detersive surfactant to cationic detersive surfactant is in the range of from 5:1 to 25:1, more preferably from 5:1 to 20:1 or from 6:1 to 15:1, or from 7:1 to 10:1, or even from 8:1 to 9:1.

Typically, the detergent composition comprises from 1 to 50 wt % anionic surfactant, more typically from 2 to 40 wt %. Alkyl benzene sulphonates are preferred anionic surfactants.

Preferred compositions of the present invention comprise at least two different surfactants in combination comprising at least one selected from a first group, the first group comprising alkyl benzene sulphonate and MES surfactant; and at least one selected from a second group, the second group comprising alkoxylated anionic surfactant, MES and alkoxylated non-ionic surfactant and alpha olefin sulfonates (AOS). A particularly preferred combination comprises alkyl benzene sulphonate, preferably LAS in combination with MES. A further particularly preferred combination comprises alkyl benzene sulphonate, preferably LAS with an alkoxylated anionic surfactant, preferably C₈₋₁₈ alkyl alkoxylated sulphate having an average degree of alkoxylation of from 1 to 10. A third particularly preferred combination comprises alkyl benzene sulphonate, preferably LAS in combination with an alkoxylated non-ionic surfactant, preferably C₈₋₁₈ alkyl ethoxylated alcohol having a degree of alkoxylation of from 15 to 50, preferably from 20 to 40.

The weight ratio of the surfactant from the first group to the weight ratio of the surfactant from the second group is typically 1:5 to 100:1, preferably 1:2 to 100:1 or 1:1 to 50:1 or even to 20:1 or 10:1. The levels of the surfactants are as described above under the specific classes of surfactants. Presence of AE3S and/or MES in the system is preferred on account of their exceptional hardness-tolerance and ability to disperse lime soaps which are formed during the wash by lipase.

In a further embodiment, the surfactant in the detergent compositions of the invention comprises at least three surfactants, at least one from each of the first and second groups defined above and in addition a third surfactant, preferably also from the first or second groups defined above.

The detergent compositions of the invention may surprisingly contain relatively low levels of surfactant and yet still perform good cleaning, on account of the soil removal functionality delivered by the lipase, so that the overall level of surfactant may be below 12 wt %, or 10 wt % or 8 wt % based on total weight of the composition

### Polymeric Polycarboxylate

It may be desired for the compositions of the invention to comprise at least 0.1 wt %, or at least 0.5 wt %, or at least 2 or 3 wt %, or even at least 5 wt % polymeric polycarboxylates up to levels of 30 wt % or 20 wt % or 10 wt %. Preferred polymeric polycarboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da. Suitable polycarboxylates are the Sokalan CP, PA and HP ranges (BASF) such as Sokalan CP5, PA40 and HP22, and the Alcosperse range of polymers (Alco) such as Alcosperse 725, 747, 408, 412 and 420.

### Soil Dispersant

It may also be preferred for the composition to comprise a soil dispersant having the formula:

bis((C₂H₅O)(C₂H₄O)n)(CH₃)—N⁺—CₓH₂ₓ—N⁺—(CH₃)-bis((C₂H₅O)(C₂H₄O)n)

wherein, n=from 20 to 30, and x=from 3 to 8. Other suitable soil dispersants are sulphonated or sulphated soil dispersants having the formula:

sulphonated or sulphated bis((C₂H₅O)(C₂H₄O)n)(CH₃)—N⁺—CₓH₂ₓ—N⁺—(CH₃)—bis((C₂H₅O)(C₂H₄O)n)

wherein, n=from 20 to 30, and x=from 3 to 8. Preferably, the composition comprises at least 1 wt %, or at least 2 wt %, or at least 3 wt % soil dispersants.

In a preferred embodiment of the invention, the detergent composition also comprises a suds booster, typically in amounts from 0.01 to 10 wt %, preferably in amounts from 0.02 to 5 wt % based on the total weight of the composition. Suitable suds boosters include fatty acid amides, fatty acid alkalonamides, betaines, sulfobetaines and amine oxides. Particularly preferred materials are cocamidopropyl betaine, cocomonoethanolamide and amine oxide. A suitable amine oxide is Admox 12, supplied by Albemarle.

### Lime Soap Dispersants

It may also be preferred for the composition to comprise, especially when a lipase is present, anti-redeposition polymers such as the polymeric polycarboxylates described above. In addition, or alternatively, cellulose ethers such as carboxymethyl cellulose (CMC) will be useful. A suitable CMC is Tylose CR1500 G2, sold by Clariant. Suitable polymers are also sold by Andercol, Colombia under the Textilan brand name.

It is especially preferred to include additives with lime soap dispersancy functionality such as the aforementioned MES, AES, highly ethoxylated nonionic surfactant or polymers showing excellent lime soap dispersancy such as Acusol 460N (Rohm & Haas). Lists of suitable lime soap dispersants are given in the following references and documents cited therein.

WO9407974 (P&G), WO9407984 (P&G), WO9407985 (P&G), WO9504806 (P&G), WO9703379 (P&G), U.S. Pat. No. 6,770,610 (Clariant), EP0324568 (Rohm & Haas), EP0768370 (Rohm & Haas), M. K. Nagarajan and W. F. Masler, Cosmetics and Toiletries, 1989, 104, pp 71-73, W. M. Linfield, Tenside Surf. Det, 1990, 27, pp 159-161, R. G. Bistline et al, J. Am. Oil Chem. Soc, 1972, 49, pp 63-69

Presence of a soil release polymer has been found to be especially beneficial in further strengthening the stain removal and cleaning benefits of the development, especially on synthetic fibres. Modified cellulose ethers such as methyl hydroxyethyl cellulose (MHEC), for example as sold by Clariant as Tylose MH50 G4 and Tylose MH300 G4, are preferred. Polyester-based Soil Release Polymers are especially preferred as they can also be effective as lime soap dispersants. Examples of suitable materials are Repel-o-Tex PF (supplied by Rhodia), Texcare SRA100 (supplied by Clariant) and Sokalan SR100 (BASF)

The detergent compositions of the invention may be in any convenient form such as solids such as powdered or granular or tablet solids, bars. Any of these forms may be partially or completely encapsulated. However, the present invention particularly relates to solid detergent compositions, especially granular compositions. Where the detergent compositions of the invention are solid, conventionally, surfactants are incorporated into agglomerates, extrudates or spray dried particles along with solid materials, usually builders, and these may be admixed to produce a fully formulated detergent composition according to the invention. When present in the granular form the detergent compositions of the present invention are preferably those having an overall bulk density of from 350 to 1200 g/l, more preferably 450 to 1000 g/l or even 500 to 900 g/l. Preferably, the detergent particles of the detergent composition in a granular form have a size average particle size of from 200 μm to 2000 μm, preferably from 350 μm to 600 μm.

Generally the detergent compositions of the invention will comprise a mixture of detergent particles including combinations of agglomerates, spray-dried powders and/or dry added materials such as bleaching agents, enzymes etc.

In one aspect of the invention the detergent compositions of the invention comprise an anionic surfactant from the list above which is a non-alkoxylated anionic detersive surfactant and this is preferably incorporated into the detergent composition in particulate form, such as via an agglomerate, a spray-dried powder, an extrudate, a bead, a noodle, a needle or a flake. Spray-dried particles are preferred. If via an agglomerate, the agglomerate preferably comprises at least 20%, by weight of the agglomerate, of a non-alkoxylated anionic detersive surfactant, more preferably from 25 wt % to 65 wt %, by weight of the agglomerate, of a non-alkoxylated anionic detersive surfactant. It may be preferred for part of the non-alkoxylated anionic detersive surfactant to be in the form of a spray-dried powder (e.g. a blown powder), and for part of the non-alkoxylated anionic detersive surfactant to be in the form of a non-spray-dried powder (e.g. an agglomerate, or an extrudate, or a flake such as a linear alkyl benzene sulphonate flake; suitable linear alkyl benzene sulphonate flakes are supplied by Pilot Chemical under the tradename F90®, or by Stepan under the tradename Nacconol 90G®. This is especially preferred when it is desirable to incorporate high levels of non-alkoxylated anionic detersive surfactant in the composition.

Any alkoxylated anionic detersive surfactant may be incorporated into the detergent compositions of the invention via a spray-dried particle of a non-spray-dried powder such as an extrudate, agglomerate, preferably an agglomerate. Non-spray dried particles are preferred when it is desirable to incorporate high levels of alkoxylated anionic detersive surfactant in the composition

Any non-ionic detersive surfactant, or at least part thereof, can be incorporated into the composition in the form of a liquid spray-on, wherein the non-ionic detersive surfactant, or at least part thereof, in liquid form (e.g. in the form of a hot-melt) is sprayed onto the remainder of the composition. The non-ionic detersive surfactant, or at least part thereof, may be in included into a particulate for incorporation into the detergent composition of the invention and the non-ionic detersive surfactant, or at least part thereof, may be dry-added to the remainder of the composition. The non-ionic surfactant, or at least part thereof, may be in the form of a co-particulate admixture with a solid carrier material such as carbonate salt, sulphate salt, burkeite, silica or any mixture thereof.

Any non-ionic detersive surfactant, or at least part thereof, may be in a co-particulate admixture with either an alkoxylated anionic detersive surfactant, a non-alkoxylated anionic detersive surfactant or a cationic detersive surfactant. The non-ionic detersive surfactant, or at least part thereof, may be agglomerated or extruded with either an alkoxylated anionic detersive surfactant, a non-alkoxylated anionic detersive surfactant or a cationic detersive surfactant.

The cationic detersive surfactant if present may be incorporated into the composition by incorporation in a particulate, such as a spray-dried powder, an agglomerate, an extrudate, a flake, a noodle, a needle, or any combination thereof. Preferably, the cationic detersive surfactant, or at least part thereof, is in the form of a spray-dried powder or an agglomerate.

### First, Second and Third Surfactant Components

In a further aspect of the invention a detergent composition is provided comprising granular components, and comprising at least two separate surfactant components or even at least three separate surfactant components: a first, a second and an optional third surfactant component. These separate surfactant components may be present in separate particulates so that at least two surfactant components are separate from one another in the detergent composition.

The composition preferably comprises at least two separate surfactant components, each in particulate form. It may be preferred for the composition to comprise at least three separate surfactant components, each in particulate form.

The first surfactant component predominantly comprises an alkoxylated detersive surfactant. By predominantly comprises, it is meant that the first surfactant component comprises greater than 50%, by weight of the first surfactant component, of an alkoxylated anionic detersive surfactant, preferably greater than 60%, or greater than 70%, or greater than 80%, or greater than 90% or even essentially 100%, by weight of the first surfactant component, of an alkoxylated anionic detersive surfactant. Preferably, the first surfactant component comprises less than 10%, by weight of the first surfactant component, of a non-alkoxylated anionic detersive surfactant, preferably less than 5%, or less than 2%, or even 0%, by weight of the first surfactant component, of a non-alkoxylated anionic detersive surfactant. Preferably, the first surfactant component is essentially free from non-alkoxylated anionic detersive surfactant. By essentially free from non-alkoxylated anionic detersive surfactant it is typically meant that the first surfactant component comprises no deliberately added non-alkoxylated anionic detersive surfactant. This is especially preferred in order to ensure that the composition has good dispensing and dissolution profiles, and also to ensure that the composition provides a clear wash liquor upon dissolution in water.

If cationic detersive surfactant is present in the composition, then preferably the first surfactant component comprises less than 10%, by weight of the first surfactant component, of a cationic detersive surfactant, preferably less than 5%, or less than 2%, or even 0%, by weight of the first surfactant component, of a cationic detersive surfactant. Preferably, the first surfactant component is essentially free from cationic detersive surfactant. By essentially free from cationic detersive surfactant it is typically meant that the first surfactant component comprises no deliberately added cationic detersive surfactant. This is especially preferred in order to reduce the degree of surfactant gelling in the wash liquor.

The first surfactant component is preferably in the form of a spray-dried powder, an agglomerate, an extrudate or a flake. If the first surfactant component is in the form of an agglomerate particle or an extrudate particle, then preferably the particle comprises from 20% to 65%, by weight of the particle, of an alkoxylated anionic detersive surfactant. If the first surfactant component is in spray-dried particle form, then preferably the particle comprises from 10 wt % to 30 wt %, by weight of the particle, of an alkoxylated anionic detersive surfactant. The first surfactant component may be in the form of a co-particulate admixture with a solid carrier material. The solid carrier material can be a sulphate salt and/or a carbonate salt, preferably sodium sulphate and/or sodium carbonate.

The second surfactant component predominantly comprises a non-alkoxylated detersive surfactant. By predominantly comprises, it is meant the second surfactant component comprises greater than 50%, by weight of the second surfactant component, of a non-alkoxylated anionic detersive surfactant, preferably greater than 60%, or greater than 70%, or greater than 80%, or greater than 90% or even essentially 100%, by weight of the second surfactant component, of a non-alkoxylated anionic detersive surfactant. Preferably, the second surfactant component comprises less than 10%, by weight of the second surfactant component, of an alkoxylated anionic detersive surfactant, preferably less than 5%, or less than 2%, or even 0%, by weight of the second surfactant component, of an alkoxylated anionic detersive surfactant. If cationic detersive surfactant is present in the composition, then preferably the second surfactant component comprises less than 10%, by weight of the second surfactant component, of a cationic detersive surfactant, preferably less than 5%, or less than 2%, or even 0%, by weight of the second surfactant component, of a cationic detersive surfactant. Preferably, the second surfactant component is essentially free from alkoxylated anionic detersive surfactant. By essentially free from alkoxylated anionic detersive surfactant it is typically meant that the second surfactant component comprises no deliberately added alkoxylated anionic detersive surfactant. Preferably, the second surfactant component is essentially free from cationic detersive surfactant. By essentially free from cationic detersive surfactant it is typically meant that the second surfactant component comprises no deliberately added cationic detersive surfactant. This is especially preferred in order to ensure that the composition has good dispensing and dissolution profiles, and also to ensure that the composition provides a clear wash liquor upon dissolution in water.

The second surfactant component may be in the form of a spray-dried powder, a flash-dried powder, an agglomerate or an extrudate. If the second surfactant component is in the form of an agglomerate particle, then preferably the particle from 5% to 50%, by weight of the particle, of a non-alkoxylated anionic detersive surfactant, or from 5 wt % to 25 wt % non-alkoxylated anionic detersive surfactant. The second surfactant component may be in form of a co-particulate admixture with a solid carrier material. The solid carrier material can be a sulphate salt and/or a carbonate salt, preferably sodium sulphate and/or sodium carbonate.

Although the detergent compositions of the invention may be substantially free of cationic surfactant, if present, the cationic surfactant may be present in a third surfactant component or may be incorporated into a spray-dried particle with at least some anionic surfactant. If present in a third component, it may be beneficial to have the third surfactant component predominantly comprising a cationic detersive surfactant. By predominantly comprises, it is meant the third surfactant component comprises greater than 50%, by weight of the third surfactant component, of a cationic detersive surfactant, preferably greater than 60%, or greater than 70%, or greater than 80%, or greater than 90% or even essentially 100%, by weight of the third surfactant component, of a cationic detersive surfactant. Preferably, the third surfactant component comprises less than 10%, by weight of the third surfactant component, of an alkoxylated anionic detersive surfactant, preferably less than 5%, or less than 2%, or even essentially 0%, by weight of the third surfactant component, of an alkoxylated anionic detersive surfactant. Preferably the third surfactant component comprises less than 10%, by weight of the third surfactant component, of a non-alkoxylated anionic detersive surfactant, preferably less than 5%, or less than 2%, or even 0%, by weight of the third surfactant component, of a non-alkoxylated anionic detersive surfactant. Preferably, the third surfactant component is essentially free from alkoxylated anionic detersive surfactant. By essentially free from alkoxylated anionic detersive surfactant it is typically meant that the third surfactant component comprises no deliberately added alkoxylated anionic detersive surfactant. Preferably, the third surfactant component is essentially free from non-alkoxylated anionic detersive surfactant. By essentially free from non-alkoxylated anionic detersive surfactant it is typically meant that the third surfactant component comprises no deliberately added non-alkoxylated anionic detersive surfactant. This is especially preferred in order to ensure that the composition has good dispensing and dissolution profiles, and also to ensure that the composition provides a clear wash liquor upon dissolution in water.

The third surfactant component is preferably in the form of a spray-dried powder, a flash-dried powder, an agglomerate or an extrudate. If the third surfactant component is in the form of an agglomerate particle, then preferably the particle comprises from 5% to 50%, by weight of the particle, of cationic detersive surfactant, or from 5 wt % to 25 wt % cationic detersive surfactant. The third surfactant component may be in form of a co-particulate admixture with a solid carrier material. The solid carrier material can be a sulphate salt and/or a carbonate salt, preferably sodium sulphate and/or sodium carbonate.

### Optional Detersive Adjuncts

Optionally, the detergent ingredients can include one or more other detersive adjuncts or other materials for assisting or enhancing cleaning performance, treatment of the substrate to be cleaned, or to modify the aesthetics of the detergent composition. Usual detersive adjuncts of detergent compositions include the ingredients set forth in U.S. Pat. No. 3,936,537, Baskerville et al. and in Great Britain Patent Application No. 9705617.0, Trinh et al., published Sep. 24, 1997. Such adjuncts are included in detergent compositions at their conventional art-established levels of use, generally from 0 wt % to about 80 wt % of the detergent ingredients, preferably from about 0.5 wt % to about 20 wt % and can include color speckles, suds boosters, suds suppressors, antitarnish and/or anticorrosion agents, soil-suspending agents, soil release agents, dyes, fillers, optical brighteners, germicides, alkalinity sources, hydrotropes, antioxidants, enzymes, enzyme stabilizing agents, solvents, solubilizing agents, chelating agents, clay soil removal/anti-redeposition agents, polymeric dispersing agents, processing aids, fabric softening components, static control agents, bleaching agents, bleaching activators, bleach stabilizers, dye-transfer inhibitors, flocculants, fabric softeners, suds suppressors, fabric integrity agents, perfumes, whitening agents, alkali metal sulphate salts, sulphamic acid, sodium sulphate and sulphamic acid complexes, etc and combinations thereof. The precise nature of these additional components, and levels of incorporation thereof will depend on the physical form of the composition or component, and the precise nature of the washing operation for which it is to be used.

Preferred zwitterionic surfactants comprise one or more quaternized nitrogen atoms and one or more moieties selected from the group consisting of: carbonate, phosphate, sulphate, sulphonate, and combinations thereof. Preferred zwitterionic surfactants are alkyl betaines. Other preferred zwitterionic surfactants are alkyl amine oxides. Catanionic surfactants which are complexes comprising a cationic surfactant and an anionic surfactant may also be included. Typically, the molar ratio of the cationic surfactant to anionic surfactant in the complex is greater than 1:1, so that the complex has a net positive charge.

A preferred adjunct component is a bleaching agent. Preferably, the detergent composition comprises one or more bleaching agents. Typically, the composition comprises (by weight of the composition) from 1% to 50% of one or more bleaching agent. Preferred bleaching agents are selected from the group consisting of sources of peroxide, sources of peracid, bleach boosters, bleach catalysts, photo-bleaches, and combinations thereof. Preferred sources of peroxide are selected from the group consisting of: perborate monohydrate, perborate tetra-hydrate, percarbonate, salts thereof, and combinations thereof. Preferred sources of peracid are selected from the group consisting of: bleach activator typically with a peroxide source such as perborate or percarbonate, preformed peracids, and combinations thereof. Preferred bleach activators are selected from the group consisting of: oxy-benzene-sulphonate bleach activators, lactam bleach activators, imide bleach activators, and combinations thereof. A preferred source of peracid is tetra-acetyl ethylene diamine (TAED) and peroxide source such as percarbonate. Preferred oxy-benzene-sulphonate bleach activators are selected from the group consisting of: nonanoyl-oxy-benzene-sulphonate, 6-nonamido-caproyl-oxy-benzene-sulphonate, salts thereof, and combinations thereof. Preferred lactam bleach activators are acyl-caprolactams and/or acyl-valerolactams. A preferred imide bleach activator is N-nonanoyl-N-methyl-acetamide.

Preferred preformed peracids are selected from the group consisting of N,N-pthaloyl-amino-peroxycaproic acid, nonyl-amido-peroxyadipic acid, salts thereof, and combinations thereof. Preferably, the STW-composition comprises one or more sources of peroxide and one or more sources of peracid. Preferred bleach catalysts comprise one or more transition metal ions. Other preferred bleaching agents are di-acyl peroxides. Preferred bleach boosters are selected from the group consisting of: zwitterionic imines, anionic imine polyions, quaternary oxaziridinium salts, and combinations thereof. Highly preferred bleach boosters are selected from the group consisting of: aryliminium zwitterions, aryliminium polyions, and combinations thereof. Suitable bleach boosters are described in U.S. 360568, U.S. Pat. No. 5,360,569 and U.S. Pat. No. 5,370,826.

A preferred adjunct component is an anti-redeposition agent. Preferably, the detergent composition comprises one or more anti-redeposition agents. Preferred anti-redeposition agents are cellulosic polymeric components, most preferably carboxymethyl celluloses.

A preferred adjunct component is a chelant. Preferably, the detergent composition comprises one or more chelants. Preferably, the detergent composition comprises (by weight of the composition) from 0.01% to 10% chelant, or 0.01 to 5 wt % or 4 wt % or 2 wt %. Preferred chelants are selected from the group consisting of: hydroxyethane-dimethylene-phosphonic acid (HEDP), 2-phosphonobutane-1,2,4-tricarboxylic acid (PBTC), ethylene diamine tetra(methylene phosphonic) acid, diethylene triamine pentacetate, ethylene diamine tetraacetate, diethylene triamine penta(methyl phosphonic) acid, ethylene diamine disuccinic acid, and combinations thereof. A further preferred chelant is an anionically modified catechol. An anionically modified catechol, as used herein, means 1,2-benzenediol having one or two anionic substitutions on the benzene ring. The anionic substitutions may be selected from sulfonate, sulfate, carbonate, phosphonate, phosphate, fluoride, and mixtures thereof. One embodiment of an anionically modified catechol having two sulfate moieties having a sodium cation on the benzene ring is 4,5-dihydroxy-m-benzenedisulfonic acid, disodium salt (Tiron®). Preferably, the anionically modified catechol is essentially free (less than 3%) of catechol (1,2-benzenediol), to avoid skin irritation when present.

A preferred adjunct component is a dye transfer inhibitor. Preferably, the detergent composition comprises one or more dye transfer inhibitors. Typically, dye transfer inhibitors are polymeric components that trap dye molecules and retain the dye molecules by suspending them in the wash liquor. Preferred dye transfer inhibitors are selected from the group consisting of: polyvinylpyrrolidones, polyvinylpyridine N-oxides, polyvinylpyrrolidone-polyvinylimidazole copolymers, and combinations thereof.

Preferred adjunct components include other enzymes. Preferred enzymes are selected from then group consisting of: amylases, arabinosidases, carbohydrases, cellulases, chondroitinases, cutinases, dextranases, esterases, β-glucanases, gluco-amylases, hyaluronidases, keratanases, laccases, ligninases, lipoxygenases, malanases, mannanases, oxidases, pectinases, pentosanases, peroxidases, phenoloxidases, phospholipases, proteases, pullulanases, reductases, tannases, transferases, xylanases, xyloglucanases, and combinations thereof. Preferred additional enzymes are selected from the group consisting of: lipases, amylases, carbohydrases, cellulases, proteases, and combinations thereof, more preferably a lipase, for further improved cleaning and whitening performance.

Preferred adjunct components include fluorescent whitening agents. Any fluorescent whitening agent suitable for use in a laundry detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives. Examples of the diaminostilbene-sulphonic acid derivative type of fluorescent whitening agents include the sodium salts of:
4,4′-bis-(2-diethanolamino-4-anilino-s-triazin-6-ylamino) stilbene-2,2′-disulphonate,
4,4′-bis-(2,4-dianilino-s-triazin-6-ylamino) stilbene-2,2′-disulphonate,
4,4′-bis-(2-anilino-4(N-methyl-N-2-hydroxy-ethylamino)-s-triazin-6-ylamino) stilbene-2,2′-disulphonate,
4,4′-bis-(4-phenyl-2,1,3-triazol-2-yl)stilbene-2,2′-disulphonate,
4,4′-bis-(2-anilino-4(1-methyl-2-hydroxy-ethylamino)-s-triazin-6-ylamino) stilbene-2,2′-disulphonate and,
2-(stilbyl-4″-naptho-1,2′:4,5)-1,2,3-trizole-2″-sulphonate.

Preferred fluorescent whitening agents are Tinopal® DMS and Tinopal® CBS available from Ciba-Geigy AG, Basel, Switzerland. Tinopal® DMS is the disodium salt of 4,4′-bis-(2-morpholino-4 anilino-s-triazin-6-ylamino) stilbene disulphonate. Tinopal® CBS is the disodium salt of 2,2′-bis-(phenyl-styryl) disulphonate.

Also preferred are fluorescent whitening agents of the structure:

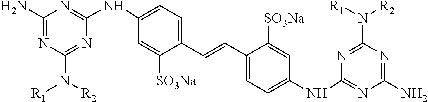

wherein R1 and R2, together with the nitrogen atom linking them, form an unsubstituted or C1-C4 alkyl-substituted morpholino, piperidine or pyrrolidine ring, preferably a morpholino ring (commercially available as Parawhite KX, supplied by Paramount Minerals and Chemicals, Mumbai, India). Other fluorescers suitable for use in the invention include the 1-3-diaryl pyrazolines and the 7-alkylaminocoumarins. Typical levels of fluorescent whitening agent in the composition are from 0.03-0.5%, preferably 0.05% to 0.3% by weight.

A preferred adjunct component is a fabric integrity agent. Preferably, the detergent composition comprises one or more fabric integrity agents. Typically, fabric integrity agents are polymeric components that deposit on the fabric surface and prevent fabric damage during the laundering process. Preferred fabric integrity agents are hydrophobically modified celluloses. These hydrophobically modified celluloses reduce fabric abrasion, enhance fibre-fibre interactions and reduce dye loss from the fabric. A preferred hydrophobically modified cellulose is described in WO99/14245. Other preferred fabric integrity agents are polymeric components and/or oligomeric components that are obtainable, preferably obtained, by a process comprising the step of condensing imidazole and epichlorhydrin.

A preferred adjunct component is a salt. Preferably, the detergent composition comprises one or more salts. The salts can act as alkalinity agents, buffers, builders, co-builders, encrustation inhibitors, fillers, pH regulators, stability agents, and combinations thereof. Typically, the detergent composition comprises (by weight of the composition) from 5% to 60% salt. Preferred salts are alkali metal salts of aluminate, carbonate, chloride, bicarbonate, nitrate, phosphate, silicate, sulphate, and combinations thereof. Other preferred salts are alkaline earth metal salts of aluminate, carbonate, chloride, bicarbonate, nitrate, phosphate, silicate, sulphate, and combinations thereof. Especially preferred salts are sodium sulphate, sodium carbonate, sodium bicarbonate, sodium silicate, sodium sulphate, and combinations thereof. Optionally, the alkali metal salts and/or alkaline earth metal salts may be anhydrous.

A preferred adjunct component is a soil release agent. Preferably, the detergent composition comprises one or more soil release agents. Typically, soil release agents are polymeric compounds that modify the fabric surface and prevent the redeposition of soil on the fabric. Preferred soil release agents are copolymers, preferably block copolymers, comprising one or more terephthalate unit. Preferred soil release agents are copolymers that are synthesised from dimethylterephthalate, 1,2-propyl glycol and methyl capped polyethyleneglycol. Other preferred soil release agents are anionically end capped polyesters.

### Softening System

The detergent compositions of the invention may comprise softening agents for softening through the wash such as clay optionally also with flocculent and enzymes. Further more specific description of suitable detergent components can be found in WO97/11151.

### Washing Method

The invention also includes methods of washing textiles comprising contacting textiles with an aqueous solution comprising the detergent composition of the invention. The invention may be particularly beneficial at low water temperatures such as below 30° C. or below 25 or 20° C. Typically the aqueous wash liquor will comprise at least 100 ppm, or at least 500 ppm of the detergent composition.

### EXAMPLES

The following are examples of the invention.

### Examples 1-6

Granular laundry detergent compositions designed for handwashing or top-loading washing machines.

| | 1 | 2 | 3 | 4 | 5 | 6 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 0.2 | 1 | 0.6 | 0.0 | 0 |
| ammonium chloride | | | | | | |
| AE3S | 0.9 | 1 | 0.9 | 0.0 | 0.5 | 0.9 |
| AE7 | 0.0 | 0.0 | 0.0 | 1 | 0.0 | 3 |
| Sodium tripolyphosphate | 5 | 0.0 | 4 | 3 | 2 | 0.0 |
| Zeolite A | 0.0 | 1 | 0.0 | 1 | 4 | 1 |
| 1.6R Silicate (SiO₂:Na₂O at | 4 | 5 | 2 | 3 | 3 | 5 |
| ratio 1.6:1) | | | | | | |
| Sodium Carbonate | 25 | 20 | 25 | 17 | 25 | 23 |
| Polyacrylate MW 4500 | 1 | 0.6 | 1 | 1 | 1.5 | 1 |
| Carboxy Methyl Cellulose | 1 | 0.3 | 1 | 1 | 1 | 1 |
| Celluclean ® (15.6 mg/g) | 0.1 | 0.2 | 0.1 | 0.2 | 0.1 | 0.1 |
| Savinase ® 32.89 mg/g | 0.1 | 0.1 | 0.1 | 0.1 | 0.1 | 0.1 |
| Natalase ® 8.65 mg/g | 0.1 | 0.0 | 0.1 | 0.0 | 0.1 | 0.1 |
| Lipex ® 18 mg/g | 0.03 | 0.07 | 0.3 | 0.1 | 0.07 | 0.4 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| Diethylenetriamine pentaacetic | 0.6 | 0 | 0.6 | 0.25 | 0.6 | 0.6 |
| acid or Ethylene diamine | | | | | | |
| tetraacetic acid | | | | | | |
| MgSO₄ | 1 | 1 | 1 | 0.5 | 1 | 1 |
| Sodium Percarbonate | 0.0 | 0 | 0.1 | 0.0 | 0.0 | 0.0 |
| Sodium Perborate Monohydrat | 4.4 | 0.0 | 3.85 | 2.09 | 0.78 | 3.63 |
| NOBS | 1.9 | 0.0 | 1.66 | 0.0 | 0.33 | 0.75 |
| TAED | 0.58 | 0 | 0.51 | 0.0 | 0.015 | 0.28 |
| Perfume spray-on | 0.4 | 0.4 | 0.6 | 1 | 0.3 | 0.2 |
| Starch encapsulated perfume | 0.3 | 0.2 | 0.3 | 0.2 | 0.3 | 0.3 |
| Sulfate/Moisture | Balance | Balance to | Balance to | Balance | Balance | Balance |
| | to 100% | 100% | 100% | to 100% | to 100% | to 100% |

### Examples 7-12

### Granular laundry detergent compositions designed for front-loading automatic washing machines

| | 7 | 8 | 9 | 10 | 11 | 12 |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE3S | 0 | 4.8 | 0 | 5.2 | 4 | 4 |
| Alkylsulfate | 1 | 0 | 1 | 0 | 0 | 0 |
| AE7 | 2.2 | 0 | 3.2 | 0 | 0 | 0 |
| C₁₀₋₁₂ Dimethyl | 0.75 | 0.94 | 0.98 | 0.98 | 0 | 0 |
| hydroxyethylammonium chloride | | | | | | |
| Crystalline layered silicate (δ- | 2.0 | 0 | 2.0 | 0 | 0 | 0 |
| Na₂Si₂O₅) | | | | | | |
| Zeolite A | 7 | 0 | 7 | 0 | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at ratio | 0.08 | 0 | 0.11 | 0 | 0 | 0 |
| 2:1) | | | | | | |
| Soil release agent | 0.75 | 0.72 | 0.71 | 0.72 | 0 | 0 |
| Acrylic Acid/Maleic Acid | 1.1 | 3.7 | 1.0 | 3.7 | 2.6 | 3.8 |
| Copolymer | | | | | | |
| Carboxymethylcellulose | 0.15 | 1.4 | 0.2 | 1.4 | 1 | 0.5 |
| Protease (84 mg active/g) | 0.2 | 0.2 | 0.3 | 0.15 | 0.12 | 0.13 |
| Celluclean ® (15.6 mg active/g) | 0.2 | 0.15 | 0.2 | 0.3 | 0.15 | 0.15 |
| Lipex ®(18.00 mg active/g) | 0.05 | 0.15 | 0.1 | 0 | 0 | 0 |
| Termamyl ® (25 mg active/g) | 0.1 | 0.1 | 0.1 | 0.12 | 0.1 | 0.1 |
| Natalase ® (8.65 mg active/g) | 0.1 | 0.2 | 0 | 0 | 0.15 | 0.15 |
| Termamyl ® (25 mg active/g) | 0.2 | 0.1 | 0.2 | 0 | 0.1 | 0.1 |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer | | | | | | |
| (EDDS) | | | | | | |
| Hydroxyethane di phosphonate | 0.2 | 0.2 | 0.2 | 0.2 | 0.2 | 0.2 |
| (HEDP) | | | | | | |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Starch Encapsulated Perfume | 0.2 | 0.5 | 0.3 | 0.4 | 0.3 | 0.2 |
| Suds suppressor agglomerate | 0.05 | 0.1 | 0.05 | 0.1 | 0.06 | 0.05 |
| Soap | 0.45 | 0.45 | 0.45 | 0.45 | 0 | 0 |
| Sulfate/Water & Miscellaneous: | 100% | 100% | 100% | 100% | 100% | 100% |
| Balance to | | | | | | |

Any of the above compositions is used to launder fabrics at a concentration of 7000 to 10000 ppm in water, 20-90° C., and a 5:1 water:cloth ratio. The typical pH is about 10.

### Raw Materials and Notes for Composition Examples 1-12

Linear alkylbenzenesulfonate having an average aliphatic carbon chain length C₁₁-C₁₂ supplied by Stepan, Northfield, Ill., USA
C₁₂₋₁₄ Dimethylhydroxyethyl ammonium chloride, supplied by Clariant GmbH, Sulzbach, Germany
AE3S is C₁₂₋₁₅ alkyl ethoxy (3) sulfate supplied by Stepan, Northfield, Ill., USA
AE7 is C₁₂₋₁₅ alcohol ethoxylate, with an average degree of ethoxylation of 7, supplied by Huntsman, Salt Lake City, Utah, USA
Sodium tripolyphosphate is supplied by Rhodia, Paris, France
Zeolite A was supplied by Industrial Zeolite (UK) Ltd, Grays, Essex, UK
1.6R Silicate was supplied by Koma, Nestemica, Czech Republic
Sodium Carbonate was supplied by Solvay, Houston, Tex., USA
Polyacrylate MW 4500 is supplied by BASF, Ludwigshafen, Germany
Carboxy Methyl Cellulose is Finnfix® BDA supplied by CPKelco, Arnhem, Netherlands
Savinase®, Natalase®, Lipex®, Termamyl®, Mannaway®, Celluclean® supplied by Novozymes, Bagsvaerd, Denmark
Protease (examples 7-12) described in U.S. Pat. No. 6,312,936B1 was supplied by Genencor International, Palo Alto, Calif., USA

### Fluorescent Brightener 1 is Tinopal® AMS, Fluorescent Brightener 2 is Tinopal® CBS-X.

Sulphonated zinc phthalocyanine supplied by Ciba Specialty Chemicals, Basel, Switzerland
Diethylenetriamine pentacetic acid was supplied by Dow Chemical, Midland, Mich., USA
Sodium percarbonate supplied by Solvay, Houston, Tex., USA
Sodium perborate was supplied by Degussa, Hanau, Germany
NOBS is sodium nonanoyloxybenzenesulfonate, supplied by Eastman, Batesville, Ark., USA
TAED is tetraacetylethylenediamine, supplied under the Peractive® brand name by Clariant GmbH, Sulzbach, Germany
S-ACMC is carboxymethylcellulose conjugated with C.I. Reactive Blue 19, sold by Megazyme, Wicklow, Ireland under the product name AZO-CM-CELLULOSE, product code S-ACMC.
Soil release agent is Repel-o-Tex® PF, supplied by Rhodia, Paris, France
Acrylic Acid/Maleic Acid Copolymer is molecular weight 70,000 and acrylate:maleate ratio 70:30, supplied by BASF, Ludwigshafen, Germany
Na salt of Ethylenediamine-N,N′-disuccinic acid, (S,S) isomer (EDDS) was supplied by Octel, Ellesmere Port, UK
Hydroxyethane di phosphonate (HEDP) was supplied by Dow Chemical, Midland, Mich., USA
Suds suppressor agglomerate was supplied by Dow Corning, Midland, Mich., USA.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising:
a. an alkaline bacterial enzyme exhibiting endo-beta-1,4-glucanase activity (E.C. 3.2.1.4);
b. up to 10 wt % of an anhydrous aluminosilicate and/or phosphate builder; and
c. a reserve alkalinity of 4 to 14.

2. The detergent composition according to claim 1, wherein the alkaline bacterial enzyme comprises a bacterial polypeptide endogenous to a member of the genus Bacillus.

3. The detergent composition according to claim 2, wherein the bacterial polypeptide comprises: AA349 (DSM 12648), KSM S237, 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof.

4. The detergent composition according to claim 1, wherein the alkaline bacterial enzyme comprises a polypeptide comprising:
a. at least one family 17 carbohydrate binding module; and
b. at least one family 28 carbohydrate binding module.

5. The detergent composition according to claim 1, wherein the alkaline bacterial enzyme comprises:
a. an endoglucanase having the amino acid sequence of positions 1 to position 773 of SEQ ID NO:1;
b. an endoglucanase having a sequence of at least 90% identity to the amino acid sequence of position 1 to position 773 of SEQ ID NO:1; or a fragment thereof has endo-beta-1,4-glucanase activity, when identity is determined by GAP provided in the GCG program using a GAP creation penalty of 3.0 and GAP extension penalty of 0.1; and
c. mixtures thereof.

6. The detergent composition according to claim 5, wherein the alkaline bacterial enzyme comprises by at least one of the following substitutions:
a. at position 10: glutamine, alanine, proline or methionine;
b. at position 16: asparagine or arginine;
c. at position 22: proline;
d. at position 33: histidine;
e. at position 39: alanine, threonine or tyrosine;
f. at position 76: histidine, methionine, valine, threonine or alanine;
g. at position 109: isoleucine, leucine, serine or valine;
h. at position 242: alanine, phenylalanine, valine, serine, aspartic acid, glutamic acid, leucine, isoleucine, tyrosine, threonine, methionine or glycine;
i. at position 263: isoleucine, leucine, proline or valine;
j. at position 308: alanine, serine, glycine or valine;
k. at position 462: threonine, leucine, phenylalanine or arginine;
l. at position 466: leucine, alanine or serine;
m. at position 468: alanine, aspartic acid, glycine or lysine;
n. at position 552: methionine;
o. at position 564: valine, threonine or leucine; and
p. at position 608: isoleucine or arginine.

7. The detergent composition according to claim 1, wherein the alkaline bacterial enzyme comprises an alkaline endoglucanase variant obtained by substituting the amino acid residue of a cellulase having an amino acid sequence exhibiting at least 90% identity with the amino acid sequence represented by SEQ. ID NO:2 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:2 and at a position corresponding thereto with another amino acid residue.

8. The detergent composition according to claim 7, wherein the alkaline bacterial enzyme comprises: Egl-237, Egl-1139, Egl-64, Egl-N131b, and mixtures thereof.

9. The detergent composition according to claim 1, wherein the alkaline bacterial enzyme comprises an alkaline cellulase K comprising:
a. a Cx enzymatic activity of acting on carboxymethyl cellulose along with a weak C₁ enzymatic activity and a weak beta-glucoxidase activity;
b. a Specificity on Substrates of acting on carboxymethyl cellulose (CMC), crystalline cellulose, Avicell, cellobiose, and p-nitrophenyl cellobioside (PNPC);
c. a working pH in the range of 4 to 12;
d. a stable pH values of 4.5 to 10.5 when allowed to stand at 40° C. for 10 minutes;
e. a working temperature range of from 10° C. to 65° C.;
f. a strong resistance to proteinases; and
g. a molecular weight less than 180,000±10,000,
wherein the Cx enzymatic activity of said alkaline cellulase K is not impeded by the presence of ethylenediamine tetraacetic acid (EDTA), ethyleneglycol-bis-(β-aminoethylether) N,N,N′,N″-tetraacetic acid (EGTA), N,N-bis(carboxymethyl)glycine (nitrilotriacetic acid) (NTA), sodium tripolyphosphate (STPP) and zeolite; and
wherein the Cx enzymatic activity is not impeded by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride.

10. The detergent composition according to claim 9, wherein the alkaline cellulase K is obtained by isolation from a culture product of Bacillus sp KSM-635.

11. The detergent composition according to claim 1, wherein the alkaline bacterial enzyme comprises:
a. Alkaline Cellulase K-534 from KSM 534, FERM BP 1508;
b. Alkaline Cellulase K-539 from KSM 539, FERM BP 1509;
c. Alkaline Cellulase K-577 from KSM 577, FERM BP 1510;
d. Alkaline Cellulase K-521 from KSM 521, FERM BP 1507;
e. Alkaline Cellulase K-580 from KSM 580, FERM BP 1511;
f. Alkaline Cellulase K-588 from KSM 588, FERM BP 1513;
g. Alkaline Cellulase K-597 from KSM 597, FERM BP 1514;
h. Alkaline Cellulase K-522 from KSM 522, FERM BP 1512;
i. Alkaline Cellulase E-II from KSM 522, FERM BP 1512;
j. Alkaline Cellulase E-III from KSM 522, FERM BP 1512;
k. Alkaline Cellulase K-344 from KSM 344, FERM BP 1506;
l. Alkaline Cellulase K-425 from KSM 425, FERM BP 1505; and
m. mixtures thereof.

12. The detergent composition according to claim 1, wherein the alkaline bacterial enzyme comprises an endoglucanase derived from Bacillus species KSM-N.

13. The detergent composition according to claim 1, wherein the bacterial alkaline enzyme comprises from 0.00005% by weight to 0.15% by weight of pure enzyme.

14. The detergent composition according to claim 1, comprising less than 8 wt % of said anhydrous aluminosilicate and/or phosphate builder.

15. The detergent composition according to claim 1, wherein said reserve alkalinity of from 7.5 to 14.

16. The detergent composition according to claim 1, further comprising:
a. from 0.1 to 40 wt % alkoxylated alkyl sulphate surfactant; and
b. from 0.1 to 40 wt % C₁₋₄ alkyl ester sulphonate.

17. The detergent composition according to claim 1, further comprising from 0.05 to 2 wt % of a suds booster.

18. The detergent composition according to claim 1, further comprising from 0.05 to 5 wt % of a soil release polymer.

19. The detergent composition according to claim 1, further comprising from 0.01 to 10 wt % of a chelant.

20. The detergent composition according to claim 1, further comprising a lipase enzyme (E.C. 3.1.1.3).
